(19) United States
(12) Patent Application Publication
(10) Pub. No.: US 2026/0260243 A1
(43) Pub. Date: Sep. 3, 2026

(54) DETECTING NON-COMPLIANT FORCE POST TRANSACTIONS

(71) Applicant: MASTERCARD INTERNATIONAL INCORPORATED, PURCHASE, NY (US)

(72) Inventors: Bhavy GANDHI, Banswara (IN); Anukriti SINGH, Kota (IN); Stephanie ALVAREZ, Miami, FL (US)

(21) Appl. No.: 19/069,153

(22) Filed: Mar. 3, 2025

(51) Int. Cl. G06Q 20/40

(52) U.S. Cl. CPC G06Q 20/4016; G06Q 20/405

(57) ABSTRACT

A computerized method detects and/or identifies force post transactions in a clearing data set. Clearing data is received and a sequence of rules are applied to the clearing data and associated authorization data to identify entries that match across the two data sets. The identified matching entries are filtered from the clearing data based on the sequence of rules. Entries remaining in the clearing data are identified as unmatched transactions and filtered clearing data associated with the identified unmatched transactions are generated. Clearing data associated with transactions that are permitted without authorization is removed from the filtered clearing data, yielding the remaining clearing data which includes identified non-compliant force post clearing transactions. An entity is the notified about the identified non-compliant force post clearing transactions, whereby the entity is enabled to take action to address the non-compliance (e.g., fraud or other malicious activities).

### BACKGROUND

Force post transactions, or force post clearings, are transactions that have been forced to occur without associated authorization. Such transactions are often indicative of fraud and/or disputed transactions that are important to track and analyze. Accurately identifying force post transactions that are not in compliance with regulations and/or rules established by transaction processing entities is vital for preventing and/or addressing fraud or other malicious activities.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for detecting and/or identifying force post transactions in a clearing data set is described. Clearing data is received and a sequence of rules are applied to the clearing data and associated authorization data to identify entries that match across the two data sets. The identified matching entries are filtered from the clearing data based on the sequence of rules because the matching indicates that the associated transactions have been authorized and are, therefore, not force post transactions. Entries remaining in the clearing data are identified as unmatched transactions and filtered clearing data associated with the identified unmatched transactions are generated. Clearing data associated with transactions that are permitted without authorization (e.g., based on one or more scenarios in which force post clearing is allowed) is removed from the filtered clearing data, yielding the remaining clearing data which includes identified non-compliant force post clearing transactions. An entity is the notified about the identified non-compliant force post clearing transactions, whereby the entity is enabled to take action to address the non-compliance (e.g., fraud or other malicious activities).

### BRIEF DESCRIPTION OF THE DRAWINGS

The present description will be better understood from the following detailed description read considering the accompanying drawings, wherein:

FIG. 1 is a block diagram illustrating a system configured for identifying force post transactions in transaction data and using those identified force post transactions in other data analysis;

FIG. 2 is a block diagram illustrating an example system configured for filtering transaction data using filter rules and to generate filtered transaction data;

FIG. 3 is a flowchart illustrating an example method for identifying force post clearing transactions in clearing data;

FIG. 4 is a flowchart illustrating a method for identifying force post transactions in clearing data using sequential evaluation of filter rules and allowed scenarios; and

FIG. 5 illustrates an example computing apparatus as a functional block diagram.

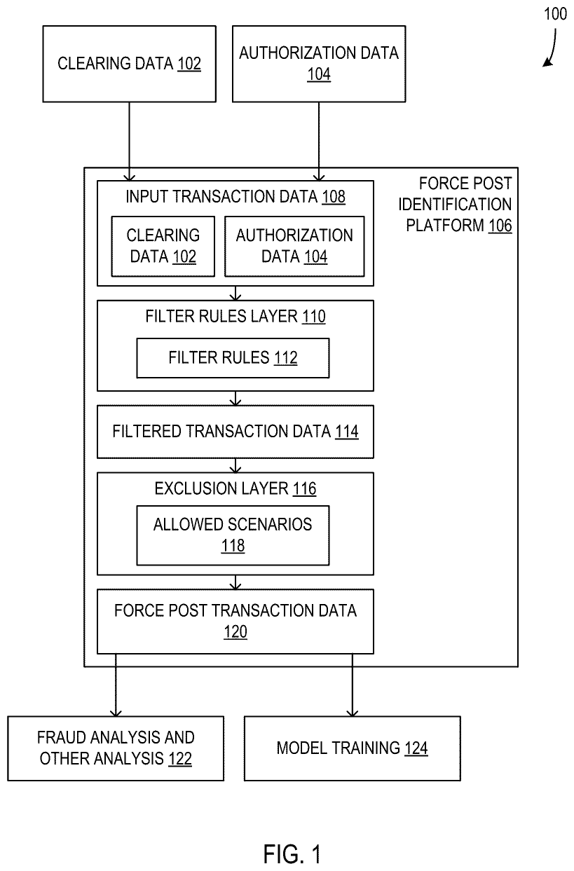

Corresponding reference characters indicate corresponding parts throughout the drawings. In FIGS. 1 to 5, the systems are illustrated as schematic drawings. The drawings may not be to scale. Any of the figures may be combined into a single example or embodiment.

### DETAILED DESCRIPTION

Aspects of the disclosure provide systems and methods for accurately and efficiently identifying force post clearing transactions in clearing data and using those identified force post clearing transactions to perform additional analysis and/or notifying interested entities. Clearing data and authorization data is received and/or obtained. A sequence of rules is applied to the clearing data and the associated authorization data to identify entries that match across the two data sets. The identified matching entries are filtered from the clearing data based on the sequence of rules because the matching indicates that the associated transactions have been authorized and are, therefore, not force post transactions. Entries remaining in the clearing data are identified as unmatched transactions and filtered clearing data associated with the identified unmatched transactions are generated. Clearing data associated with transactions that are permitted without authorization (e.g., based on one or more scenarios in which force post clearing is allowed) is removed from the filtered clearing data, yielding the remaining clearing data which includes identified non-compliant force post clearing transactions. An entity is the notified about the identified non-compliant force post clearing transactions, whereby the entity is enabled to take action to address the non-compliance (e.g., fraud or other malicious activities).

The disclosure operates in an unconventional manner at least by efficiently detecting transactions in the clearing data that have been subject to authorization so that those detected transactions can be eliminated. The sequence of rules is applied to the data in a series, with each set of input data being reduced based on detected matches in the clearing data with the authorization data from the application of the previous rule. As a result, a large quantity and wide variety of filter rules can be used while maintaining efficient use of processing resources of the system (e.g., the quantity of entries analyzed with respect to the final rules of the sequence is likely to be significantly reduced from the quantity of entries analyzed with respect to the first rule). Further, once the quantity of entries in the clearing data has been significantly reduced by the application of the filter rules, the remaining clearing data is analyzed with respect to scenarios in which force post clearing is allowed, enabling those entries associated with those allowed scenarios to also be eliminated. This sequential process provides high accuracy while reducing the computational complexity of the identification process, thereby optimizing the resource usage of the system(s) upon which the process is executed.

Aspects of the disclosure provide improved processing efficiency. The system implements a sequence of filter rules that match transactions between clearing data and authorization data, progressively reducing the transaction volume subjected to scrutiny. This approach reduces and/or optimizes computational resource usage by filtering out authorized transactions early in the process, thereby enhancing the system's processing efficiency overall.

Further, an exclusion layer identifies legitimate force post scenarios, allowing real non-compliant transactions to be efficiently isolated for analysis. Machine learning models use this transaction data to refine detection processes and improve the accuracy with which future fraud events are detected. This systematic approach reduces unnecessary processing and allows computing resources to be allocated more effectively towards analyzing suspect transactions.

Additionally, or alternatively, aspects of the disclosure include filter rules and exclusion rules that are designed for adjustability, enabling efficient tailoring and/or reactions to changes based on transaction criteria, thus enhancing the system's adaptability to changing transactional environments. Thus, the system enables adaptive management of processing demands without requiring extensive reconfiguration and the time and resource costs associated therewith.

FIG. 1 is a block diagram illustrating a system 100 configured for identifying force post transactions in transaction data and using those identified force post transactions in other data analysis. In some examples, the system 100 includes clearing data 102 and authorization data 104 which are provided to a force post identification platform 106 as input. The input transaction data 108 is filtered using a filter rules layer 110, resulting in filtered transaction data 114. The filtered transaction data 114 is then analyzed using an exclusion layer 116, resulting in the force post transaction data 120 associated with the identified force post transactions. The force post transaction data 120 is then used for at least one use, such as fraud analysis and/or other analyses 122 or model training 124.

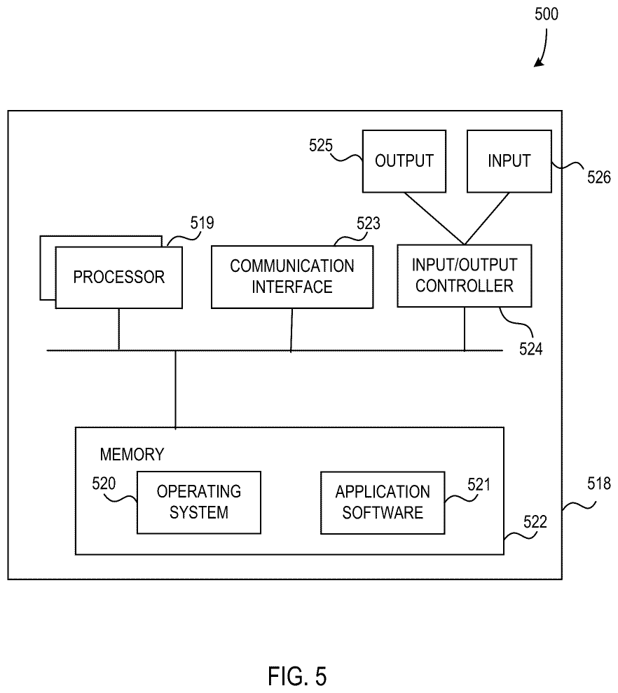

Further, in some examples, the system 100 includes one or more computing devices (e.g., the computing apparatus of FIG. 5) that are configured to communicate with each other via one or more communication networks (e.g., an intranet, the Internet, a cellular network, other wireless network, other wired network, or the like). In some examples, entities of the system 100 are configured to be distributed between multiple computing devices and to communicate with each other via network connections. For example, the force post identification platform 106 is executed on a first computing device and the clearing data 102 and/or authorization data 104 are located on a second computing device within the system 100. The first computing device and second computing device are configured to communicate with each other via network connections. Alternatively, in some examples, other components of the force post identification platform 106 (e.g., the filter rules layer 110 and/or the exclusion layer 116) are executed on separate computing devices and those separate computing devices are configured to communicate with each other via network connections during the operation of the force post identification platform 106. In other examples, other organizations of computing devices are used to implement system 100 without departing from the description.

In some examples, the clearing data 102 includes data that identifies and/or describes clearing transactions that have occurred over a period of time. The clearing data 102 includes and/or refers to information exchanged between parties in a credit card transaction during the clearing phase of the payment lifecycle. In some such examples, clearing data 102 includes identifying information of merchants, identifying information of payers, account details, transaction amounts, transaction datetimes, and/or the like. It should be understood that the clearing process with which the clearing data 102 is associated includes submission of transaction batches by merchants to acquiring banks, consolidation of the transactions by the acquiring banks, forwarding of the consolidated transactions to card networks, and routing of the transaction clearing data to issuing banks for verification.

Further, in some examples, the authorization data 104 includes data that identifies and/or describes the authorization operations of transactions that have occurred over a period of time. In some such examples, the clearing data 102 and authorization data 104 are associated with the same or similar periods of time such that entries in each set of data can be matched during the processes described herein. The authorization data 104 also includes data that identifies the parties to the transactions (e.g., merchants, banks, payers), account information, transaction amounts, transaction datetimes, and/or the like. It should be understood that a “force post transaction” as described herein bypasses the authorization process and, as a result, data associated with a force post transaction in the clearing data 102 is unlikely to have matching data in the authorization data 104. Even if there is data associated with the force post transaction in the authorization data 104, it is likely to be different from the authorization data of other non-force post transactions (e.g., the authorization data indicates that pre-authorization was used or that a manually entered authorization code was used).

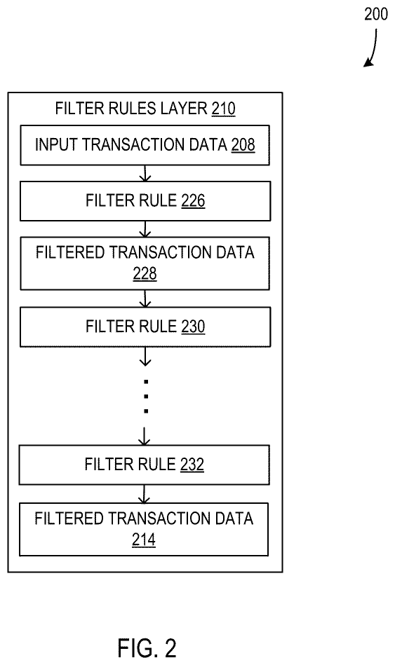

In some examples, the force post identification platform 106 includes hardware, firmware, and/or software configured to analyze the data in the clearing data 102 and the authorization data 104 and to identify force post transactions therefrom. The force post identification platform 106 receives the clearing data 102 and the authorization data 104 as input transaction data 108 and processes the input transaction data 108 using the filter rules layer 110. The filter rules layer 110 includes one or more filter rules 112 that, when applied to clearing data 102 and authorization data 104, filter out transactions that are confirmed to not be force post transaction. In some such examples, the filter rules 112 are applied to the input transaction data 108 in a series and the results of one filter rule 112 are used as input for the next filter rule 112. Thus, the processing resources required to process the data using later filter rules 112 is substantially reduced when compared to the resources required to process the initial set of input transaction data 108 due to the reduced quantity of data entries used as input. This is described in greater detail below at least with respect to FIG. 2.

The filter rules layer 110 outputs the filtered transaction data 114 which includes data associated with transactions that have not been ruled out as being force post transactions. In some such examples, the transactions included in the filtered transaction data 114 are transactions for which entries in the authorization data 104 were not found to match entries in the clearing data 102.

The filtered transaction data 114 is provided as input to the exclusion layer 116, wherein the transactions included in the filtered transaction data 114 are analyzed with respect to one or more allowed scenarios 118. The allowed scenarios 118 are scenarios during which force post transactions are expected to occur. If a transaction in the filtered transaction data 114 is found to have occurred during an allowed scenario 118, it is removed from or otherwise flagged in the data set. It should be understood that, in most examples, the force post identification platform 106 is configured to identify force post transactions that have occurred outside of the defined allowed scenarios 118, so force post transactions that occurred because of the allowed scenarios 118 are filtered out. The exclusion layer 116 is configured to perform this filtering to provide the force post transaction data 120 as output, wherein the force post transaction data 120 does not include any force post transactions that occurred because of the allowed scenarios 118. In some such examples, the allowed scenarios 118 include refunds, reversals, some types of installment transactions, or the like. In other examples, more, fewer, and/or different types of allowed scenarios 118 are used without departing from the description.

In some examples, the force post transaction data 120 includes data entries associated with force post transactions that have occurred, wherein those force post transactions did not occur in an allowed scenario 118 of the exclusion layer 116. The data entries include information that identifies the associated force post transactions (e.g., a transaction identification number or code) and/or information that describes aspects and/or details about the force post transactions (e.g., merchant identifiers, transaction datetime, location information, merchant category codes, or the like).

Further, in some examples, the force post transaction data 120 is used to perform fraud analysis and/or other types of analysis 122. The force post transaction data 120 is analyzed to identify anomalous patterns in the transactions, such as unusual transaction amounts, frequencies, or patterns compared to normal activity. Additionally, or alternatively, in some examples, merchants or accounts with high volumes of force post transactions are flagged to be observed more closely and/or to prevent future force post transactions that are fraudulent. Other types of fraud analysis 122 include analyzing transaction locations and comparing those locations to typical activity areas and/or home addresses of cardholders to identify fraudulent activity and/or identifying transactions or patterns of transactions that occurred during times when fraudulent activity is more likely (e.g., transactions that occur in the middle of the night or early morning).

Additionally, or alternatively, in some examples, the force post transaction data 120 is used for compliance and operation analysis. For instance, in some examples, the force post transaction data 120 is used to confirm that the force post transactions adhere to compliance regulations and/or to ensure that proper documentation and approval processes are followed for the force post transactions. Further, in some examples, the force post transaction data is correlated with chargeback rates to assess potential customer dissatisfaction or misuse. Additionally, or alternatively, merchants who frequently use force post codes are identified and evaluated to confirm that they are not inappropriately bypassing standard authorization.

Further, in some examples, the force post transaction data 120 is used to investigate patterns in force post transactions that indicate technical issues in the payment processing system. In some such examples, force post transactions of the data 120 are analyzed to obtain insights into customer behavior, such as high value purchasing behavior and/or emergency spending patterns. Historical trends are also used to predict when and where force post transactions are likely to occur, enabling proactive mitigation of risks associated with the force post transactions.

Additionally, or alternatively, in some examples, the force post transaction data 120 is used to identify potential issues in authorization systems and/or network outages, as well as using the data 120 to pinpoint system incompatibilities between point-of-sale systems and other components of the payment processing systems. Further, in some examples, the force post transaction data 120 is used to analyze transaction trends to optimize transaction fee structures associated with force post transactions.

In some examples, the force post transaction data 120 is used to generate reports that are used for auditing and/or to provide insights into improving policy decisions around force post transactions. Additionally, or alternatively, the data 120 is used to generate visualizations, dashboards, heatmaps, or the like that enable users to view aspects or patterns of the data 120 and to make decisions about the data 120. For instance, in an example, reports and/or visualizations are generated that reflect the force post transaction data 120 and are used to compare force post transaction trends across different regions, industries, and/or timeframes. Such comparisons enable the identification of inefficiencies and/or patterns of fraud, whereby customer experience and regulation compliance can be enhanced.

Further, in some examples, the force post transaction data 120 is used as training data for the model training 124 of Artificial Intelligence (AI)/Machine Learning (ML) models. In some such examples, the trained models are trained to identify force post transactions that have not occurred as a part of an allowed scenario 118. Such models are enabled to identify force post transactions and respond to those transactions rapidly, such that some cases of fraud can be proactively prevented. Additionally, or alternatively, in some other examples, the trained models are trained to identify other patterns within the force post transaction data 120, such as identifying a subset of force post transactions that are associated with a specific type of fraud activity.

In some examples, the model training 124 includes data preparation processes that are performed on the force post transaction data 120. For instance, the force post transaction data 120 is reformatted to a format that is compatible with the model. Further, the type of model to be trained is chosen (e.g., a classification model, a regression model, a clustering model, or the like). The training data (e.g., the force post transaction data 120) is provided to the model and internal parameters of the model are adjusted based on patterns in the training data. In some such examples, the process includes optimizing weights and/or biases using an algorithm, such as gradient descent, which minimizes errors in predictions. Additionally, or alternatively, in some examples, validation and tuning processes are performed on the model to avoid overfitting to the training data (e.g., parameters such as learning rate, regularization strength, and number of layers in the neural network of the model are fine-tuned). After the training of the model is complete, the model is assessed on test data to measure its accuracy and generalization ability. In some such examples, performance of the model is measured using metrics such as accuracy, precision, recall, and/or mean squared error. If the performance of the model is acceptable, the model may be deployed for use in classifying force post transactions. Alternatively, if the performance of the model is not yet acceptable, it may be trained again on other training data to further improve its performance.

FIG. 2 is a block diagram illustrating an example system 200 configured for filtering transaction data 208 using filter rules 226, 230, and 232 to generate filtered transaction data 214. In some examples, the filter rules layer 210 of system 200 is part of the force post identification platform 106 of FIG. 1.

The input transaction data 208 includes clearing data 108 and authorization data 104. Transactions described in the clearing data 108 and authorization data 104 are matched to each other based on the filter rules (e.g., filter rules 226, 230, and 232) and matched transactions are removed from the transaction data to form the filtered transaction data 214. The filter rules are applied in series and the transaction data is filtered after the application of each filter rule, such that the transaction data being analyzed with each filter rule becomes smaller.

In some examples, the input transaction data 208 is analyzed using the filter rule 226. Each transaction in the clearing data and authorization data that are found to match based on the filter rule 226 are removed from the transaction data 208 to form the filtered transaction data 228. Then, the filtered transaction data 228 is analyzed using the filter rule 230. Each transaction in filtered transaction data 228 that is found to match based on the filter rule 230 is removed from the filtered transaction data and that newly filtered transaction data is then used with the next filter rule. This process continues until the last filter rule 232 is used to generate the filtered transaction data 214, which is transaction data that has been completely filtered by all of the filter rules of the filter rules layer 210. It should be understood that, in other examples, more, fewer, or different filter rules are used in the filter rules layer 210 without departing from the description.

Further, in some examples, the filter rules include rules that match transactions based on matching account numbers, matching bank reference numbers, matching date, matching date time, matching authorization identification numbers, matching merchant identification numbers, matching card acceptor identification numbers, matching merchant category codes, and matching authorization trace identification numbers. Some filter rules match based on a single value, while other filter rules match based on combinations of values (e.g., a rule that matches based on account number and bank reference number, and transaction date).

In some examples, the filter rules are applied based on defined time periods. For instance, in an example, a lookback period of 120 days before the clearing process date is used when applying the filter rules (e.g., for a transaction in the clearing data, only transaction data up to 120 days prior to the clearing process date is considered when matching using the filter rules). Further, a look-forward period of 14 days after the clearing process date is used for deferred authorization purposes. In other examples, other period lengths are used without departing from the description.

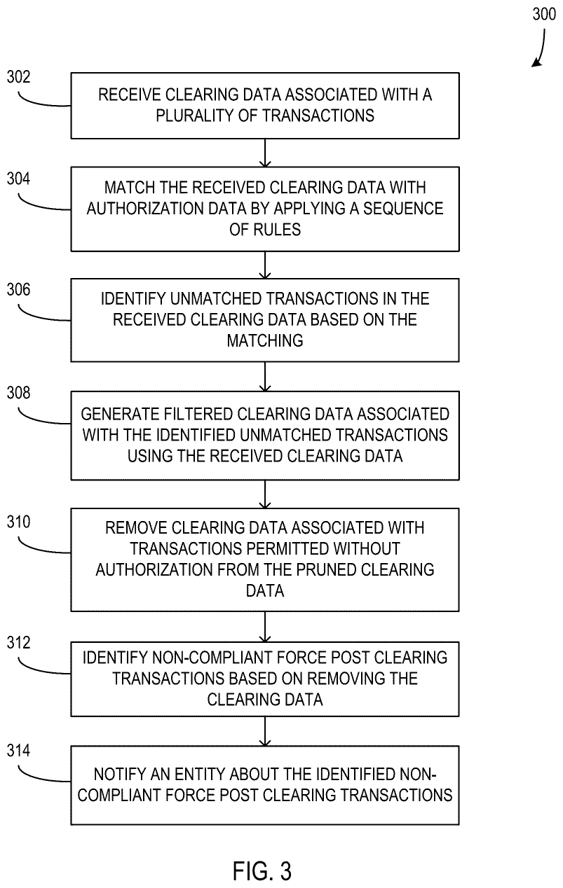

FIG. 3 is a flowchart illustrating an example method 300 for identifying force post clearing transactions in clearing data. In some examples, the method 300 is executed or otherwise performed in association with a system such as systems 100 and/or 200 of FIGS. 1 and/or 2.

At 302, clearing data associated with a plurality of transactions is received. In some examples, the received clearing data includes data from a defined time period. Further, the clearing data includes data that identifies transactions as well as data that describes aspects or details of the transactions as described herein.

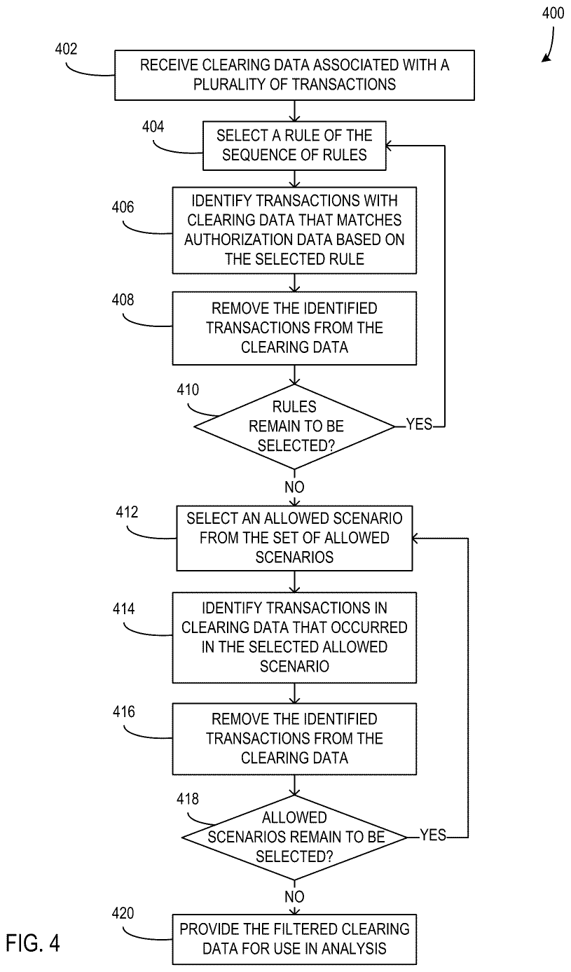

At 304, the received clearing data is matched with authorization data by applying a sequence of rules (e.g., filter rules 112). In some examples, each of the rules is evaluated in sequence and, after a rule is evaluated, transactions that are associated with matching clearing data and authorization data based on the rule are removed from the clearing data, as described in greater detail herein at least with respect to FIG. 4. Further, in some examples, the filter rules include rules that match based on individual data values and/or rules that match based on sets or groups of data values. It should be understood that, when matching data associated with a filter rule is identified in the clearing data and the authorization data, it indicates that the associated transaction was subject to both the authorization process and the clearing process. Thus, because such transactions were authorized, they are not considered to be force post transactions and are removed from the clearing data being analyzed.

At 306, unmatched transactions are identified in the received clearing data based on the matching and, at 308, filtered clearing data is generated, wherein the filtered clearing data is associated with the identified unmatched transactions using the received clearing data. In some examples, the unmatched transactions are the remaining transactions in the clearing data after the evaluation of the sequence of rules and the removal of the matching transactions.

At 310, clearing data associated with transactions that are permitted without authorization is filtered from the filtered clearing data, resulting in identification of non-compliant force post clearing transactions based on the filtering at 312. In some examples, the filtering of the filtered clearing data is performed in association with an exclusion layer 116 and associated allowed scenarios 118 as described herein.

At 314, an entity is notified about the identified non-compliant force post clearing transactions. In some examples, the notification is provided to a bank or other entity associated with the processing of the transactions, enabling the entity to respond to possible fraudulent activity. Additionally, or alternatively, in some examples, the identified non-compliant force post clearing transactions are provided for use in fraud and/or other types of analysis 122 and/or for use in model training 124.

FIG. 4 is a flowchart illustrating a method 400 for identifying force post transactions in clearing data using sequential evaluation of filter rules and allowed scenarios. In some examples, the method 400 is executed or otherwise performed in association with a system such as systems 100 and/or 200 of FIGS. 1 and/or 2.

At 402, clearing data associated with a plurality of transactions is received. At 404, a rule of the sequence of rules is selected and the clearing data is evaluated with respect to the selected rule.

At 406, transactions with clearing data that matches authorization data based on the selected rule are identified in the clearing data and, at 408, the identified transactions are removed from the clearing data.

At 410, if one or more rules remain to be selected and evaluated, the process returns to 404. Alternatively, if no rules remain to be selected and evaluated, the process proceeds to 412.

At 412, an allowed scenario is selected from the set of allowed scenarios. At 414, transactions that occurred in association with the selected allowed scenario are identified in the clearing data and, at 416, the identified transactions are then removed from the clearing data.

At 418, if one or more allowed scenarios remain to be selected and evaluated, the process returns to 412. Alternatively, if no allowed scenarios remain to be selected and evaluated, the process proceeds to 420.

At 420, the filtered clearing data is provided for use in analysis, such as fraud or other analysis 122 and/or for use in model training 124 as described herein.

It should be understood that, in other examples, the method 400 performs the described processes in different order without departing from the description. For instance, in an example, the method 400 includes evaluating the transactions in the clearing data for occurring in association with allowed scenarios first, before the application of the filter rules. In other examples, other orders of operation are used without departing from the description.

### Exemplary Operating Environment

The present disclosure is operable with a computing apparatus according to an embodiment as a functional block diagram 500 in FIG. 5. In an example, components of a computing apparatus 518 are implemented as a part of an electronic device according to one or more embodiments described in this specification. The computing apparatus 518 comprises one or more processors 519 which may be microprocessors, controllers, or any other suitable type of processors for processing computer executable instructions to control the operation of the electronic device. Alternatively, or in addition, the processor 519 is any technology capable of executing logic or instructions, such as a hard-coded machine. In some examples, platform software comprising an operating system 520 or any other suitable platform software is provided on the apparatus 518 to enable application software 521 to be executed on the device. In some examples, identifying force post clearing transactions in a clearing data set as described herein is accomplished by software, hardware, and/or firmware.

In some examples, computer executable instructions are provided using any computer-readable media that is accessible by the computing apparatus 518. Computer-readable media include, for example, computer storage media such as a memory 522 and communications media. Computer storage media, such as a memory 522, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium is not a propagating signal. Propagated signals are not examples of computer storage media. Although the computer storage medium (the memory 522) is shown within the computing apparatus 518, it will be appreciated by a person skilled in the art, that, in some examples, the storage is distributed or located remotely and accessed via a network or other communication link (e.g., using a communication interface 523).

Further, in some examples, the computing apparatus 518 comprises an input/output controller 524 configured to output information to one or more output devices 525, for example a display or a speaker, which are separate from or integral to the electronic device. Additionally, or alternatively, the input/output controller 524 is configured to receive and process an input from one or more input devices 526, for example, a keyboard, a microphone, or a touchpad. In one example, the output device 525 also acts as the input device. An example of such a device is a touch sensitive display. The input/output controller 524 may also output data to devices other than the output device, e.g., a locally connected printing device. In some examples, a user provides input to the input device(s) 526 and/or receives output from the output device(s) 525.

The functionality described herein can be performed, at least in part, by one or more hardware logic components. According to an embodiment, the computing apparatus 518 is configured by the program code when executed by the processor 519 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises a processor; and a memory comprising computer program code, the memory and the computer program code configured to cause the processor to: receive clearing data associated with a plurality of transactions; match the received clearing data with authorization data by applying a sequence of rules; identify unmatched transactions in the received clearing data based on the matching; generate filtered clearing data associated with the identified unmatched transactions using the received clearing data; remove clearing data associated with transactions permitted without authorization from the filtered clearing data; identify non-compliant force post clearing transactions based on removing the clearing data; and notify an entity about the identified non-compliant force post clearing transactions.

An example computerized method comprises receiving clearing data associated with a plurality of transactions; matching the received clearing data with authorization data by applying a sequence of rules; identifying unmatched transactions in the received clearing data based on the matching; generating filtered clearing data associated with the identified unmatched transactions using the received clearing data; removing clearing data associated with transactions permitted without authorization from the filtered clearing data; identifying non-compliant force post clearing transactions based on removing the clearing data; and notifying an entity about the identified non-compliant force post clearing transactions.

One or more computer storage media having computer-executable instructions that, upon execution by a processor, case the processor to at least: receive clearing data associated with a plurality of transactions; match the received clearing data with authorization data by applying a sequence of rules; identify unmatched transactions in the received clearing data based on the matching; generate filtered clearing data associated with the identified unmatched transactions using the received clearing data; remove clearing data associated with transactions permitted without authorization from the filtered clearing data; identify non-compliant force post clearing transactions based on removing the clearing data; and notify an entity about the identified non-compliant force post clearing transactions.

Alternatively, or in addition to the other examples described herein, examples include any combination of the following:
wherein the sequence of rules includes at least one of the following: a first rule matching account numbers; a second rule matching bank reference numbers; a third rule matching authorization identification numbers; a fourth rule matching merchant identification numbers; a fifth rule matching card acceptor identification numbers; a sixth rule matching merchant category codes; and a seventh rule matching authorization trace identification numbers.
wherein the sequence of rules includes a rule matching account numbers, bank reference numbers, and transaction dates between transactions in the received clearing data and transactions in the authorization data.
wherein matching the received clearing data with authorization data by applying a sequence of rules, identifying the unmatched transactions, and generating the filtered clearing data includes: identifying a first rule of the sequence of rules; determining a first subset of the received clearing data associated with one or more transactions of the plurality of transactions that satisfy the identified first rule; removing the determined first subset from the received clearing data to obtain a first filtered clearing data subset; identifying a second rule of the sequence of rules; determining a second subset of the first filtered clearing data subset associated with one or more transactions of the plurality of transactions that satisfy the identified second rule; and removing the determined second subset from the first filtered clearing data subset to obtained a second filtered clearing data subset.
wherein filter the transactions permitted without authorization include at least one of transactions associated refunds, transactions associated with reversals, or transactions associated with installment payments.
wherein notifying the entity about the identified non-compliant force post clearing transactions includes: identifying a fraud pattern in the identified non-compliant force post clearing transactions; determining a bank associated with a transaction with which the identified fraud pattern is associated; and notifying the determined bank about the identified fraud pattern, whereby the determined bank is enabled to take action to address fraud associated with the fraud pattern.
further comprising providing the non-compliant force post clearing transactions and associated clearing data and authorization data to a machine learning (ML) model training platform, whereby the ML model training platform is enabled to use the provided non-compliant force post clearing transactions to train a model to identify non-compliant force post clearing transactions.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for receiving clearing data associated with a plurality of transactions; exemplary means for matching the received clearing data with authorization data by applying a sequence of rules; exemplary means for identifying unmatched transactions in the received clearing data based on the matching; exemplary means for generating filtered clearing data associated with the identified unmatched transactions using the received clearing data; exemplary means for removing clearing data associated with transactions permitted without authorization from the filtered clearing data; exemplary means for identifying non-compliant force post clearing transactions based on removing the clearing data; and exemplary means for notifying an entity about the identified non-compliant force post clearing transactions.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a memory comprising computer program code, the memory and the computer program code configured to cause the processor to:
receive clearing data associated with a plurality of transactions;
match the received clearing data with authorization data by applying a sequence of rules;
identify unmatched transactions in the received clearing data based on the matching;
generate filtered clearing data associated with the identified unmatched transactions using the received clearing data;
remove clearing data associated with transactions permitted without authorization from the filtered clearing data;
identify non-compliant force post clearing transactions based on removing the clearing data; and
notify an entity about the identified non-compliant force post clearing transactions.

2. The system of claim 1, wherein the sequence of rules includes at least one of the following:
a first rule matching account numbers; a second rule matching bank reference numbers; a third rule matching authorization identification numbers; a fourth rule matching merchant identification numbers; a fifth rule matching card acceptor identification numbers; a sixth rule matching merchant category codes; and a seventh rule matching authorization trace identification numbers.

3. The system of claim 1, wherein the sequence of rules includes a rule matching account numbers, bank reference numbers, and transaction dates between transactions in the received clearing data and transactions in the authorization data.

4. The system of claim 1, wherein matching the received clearing data with authorization data by applying a sequence of rules, identifying the unmatched transactions, and generating the filtered clearing data includes:
identifying a first rule of the sequence of rules;
determining a first subset of the received clearing data associated with one or more transactions of the plurality of transactions that satisfy the identified first rule;
removing the determined first subset from the received clearing data to obtain a first filtered clearing data subset;
identifying a second rule of the sequence of rules;
determining a second subset of the first filtered clearing data subset associated with one or more transactions of the plurality of transactions that satisfy the identified second rule; and
removing the determined second subset from the first filtered clearing data subset to obtained a second filtered clearing data subset.

5. The system of claim 1, wherein filter the transactions permitted without authorization include at least one of transactions associated refunds, transactions associated with reversals, or transactions associated with installment payments.

6. The system of claim 1, wherein notifying the entity about the identified non-compliant force post clearing transactions includes:
identifying a fraud pattern in the identified non-compliant force post clearing transactions;
determining a bank associated with a transaction with which the identified fraud pattern is associated; and
notifying the determined bank about the identified fraud pattern, whereby the determined bank is enabled to take action to address fraud associated with the fraud pattern.

7. The system of claim 1, wherein the memory and the computer program code are configured to further cause the processor to provide the non-compliant force post clearing transactions and associated clearing data and authorization data to a machine learning (ML) model training platform, whereby the ML model training platform is enabled to use the provided non-compliant force post clearing transactions to train a model to identify non-compliant force post clearing transactions.

8. A computerized method comprising:
receiving clearing data associated with a plurality of transactions;
matching the received clearing data with authorization data by applying a sequence of rules;
identifying unmatched transactions in the received clearing data based on the matching;
generating filtered clearing data associated with the identified unmatched transactions using the received clearing data;
removing clearing data associated with transactions permitted without authorization from the filtered clearing data;
identifying non-compliant force post clearing transactions based on removing the clearing data; and
notifying an entity about the identified non-compliant force post clearing transactions.

9. The computerized method of claim 8, wherein the sequence of rules includes at least one of the following:
a first rule matching account numbers; a second rule matching bank reference numbers; a third rule matching authorization identification numbers; a fourth rule matching merchant identification numbers; a fifth rule matching card acceptor identification numbers; a sixth rule matching merchant category codes; and a seventh rule matching authorization trace identification numbers.

10. The computerized method of claim 8, wherein the sequence of rules includes a rule matching account numbers, bank reference numbers, and transaction dates between transactions in the received clearing data and transactions in the authorization data.

11. The computerized method of claim 8, wherein matching the received clearing data with authorization data by applying a sequence of rules, identifying the unmatched transactions, and generating the filtered clearing data includes:
identifying a first rule of the sequence of rules;
determining a first subset of the received clearing data associated with one or more transactions of the plurality of transactions that satisfy the identified first rule;
removing the determined first subset from the received clearing data to obtain a first filtered clearing data subset;
identifying a second rule of the sequence of rules;
determining a second subset of the first filtered clearing data subset associated with one or more transactions of the plurality of transactions that satisfy the identified second rule; and
removing the determined second subset from the first filtered clearing data subset to obtained a second filtered clearing data subset.

12. The computerized method of claim 8, wherein filter the transactions permitted without authorization include at least one of transactions associated refunds, transactions associated with reversals, or transactions associated with installment payments.

13. The computerized method of claim 8, wherein notifying the entity about the identified non-compliant force post clearing transactions includes:
identifying a fraud pattern in the identified non-compliant force post clearing transactions;
determining a bank associated with a transaction with which the identified fraud pattern is associated; and
notifying the determined bank about the identified fraud pattern, whereby the determined bank is enabled to take action to address fraud associated with the fraud pattern.

14. The computerized method of claim 8, further comprising providing the non-compliant force post clearing transactions and associated clearing data and authorization data to a machine learning (ML) model training platform, whereby the ML model training platform is enabled to use the provided non-compliant force post clearing transactions to train a model to identify non-compliant force post clearing transactions.

15. A computer storage medium has computer-executable instructions that, upon execution by a processor, cause the processor to at least:
receive clearing data associated with a plurality of transactions;
match the received clearing data with authorization data by applying a sequence of rules;
identify unmatched transactions in the received clearing data based on the matching;
generate filtered clearing data associated with the identified unmatched transactions using the received clearing data;
remove clearing data associated with transactions permitted without authorization from the filtered clearing data;
identify non-compliant force post clearing transactions based on removing the clearing data; and
notify an entity about the identified non-compliant force post clearing transactions.

16. The computer storage medium of claim 15, wherein the sequence of rules includes at least one of the following:
a first rule matching account numbers; a second rule matching bank reference numbers; a third rule matching authorization identification numbers; a fourth rule matching merchant identification numbers; a fifth rule matching card acceptor identification numbers; a sixth rule matching merchant category codes; and a seventh rule matching authorization trace identification numbers.

17. The computer storage medium of claim 15, wherein the sequence of rules includes a rule matching account numbers, bank reference numbers, and transaction dates between transactions in the received clearing data and transactions in the authorization data.

18. The computer storage medium of claim 15, wherein matching the received clearing data with authorization data by applying a sequence of rules, identifying the unmatched transactions, and generating the filtered clearing data includes:
identifying a first rule of the sequence of rules;
determining a first subset of the received clearing data associated with one or more transactions of the plurality of transactions that satisfy the identified first rule;
removing the determined first subset from the received clearing data to obtain a first filtered clearing data subset;
identifying a second rule of the sequence of rules;
determining a second subset of the first filtered clearing data subset associated with one or more transactions of the plurality of transactions that satisfy the identified second rule; and
removing the determined second subset from the first filtered clearing data subset to obtained a second filtered clearing data subset.

19. The computer storage medium of claim 15, wherein filter the transactions permitted without authorization include at least one of transactions associated refunds, transactions associated with reversals, or transactions associated with installment payments.

20. The computer storage medium of claim 15, wherein notifying the entity about the identified non-compliant force post clearing transactions includes:
identifying a fraud pattern in the identified non-compliant force post clearing transactions;
determining a bank associated with a transaction with which the identified fraud pattern is associated; and
notifying the determined bank about the identified fraud pattern, whereby the determined bank is enabled to take action to address fraud associated with the fraud pattern.
